(19) United States
(12) Patent Application Publication
(10) Pub. No.: US 2025/0092863 A1
(43) Pub. Date: Mar. 20, 2025

(54) ROADWAY EMBEDDED TRAFFIC TURBINE ASSEMBLIES AND METHODS

(71) Applicant: Jeremy Goren, Niskayuna, NY (US)

(72) Inventor: Jeremy Goren, Niskayuna, NY (US)

(21) Appl. No.: 18/965,642

(22) Filed: Dec. 2, 2024

Related U.S. Application Data
(63) Continuation-in-part of application No. 18/608,423, filed on Mar. 18, 2024.
Application No. 18/608,423 is a continuation-in-part of application No. 18/186,085, filed on Mar. 17, 2023.
(60) Provisional application No. 63/604,674, filed on Nov. 30, 2023.
(60) Provisional application No. 63/479,217, filed on Jan. 10, 2023.
(60) Provisional application No. 63/322,892, filed on Mar. 23, 2022.

(51) Int. Cl. F03G 7/08; H02K 7/18

(52) U.S. Cl. CPC F03G 7/083; H02K 7/1853

(57) ABSTRACT

Power generating devices and systems that include devices, apparatus, systems and methods with a turbine assembly disposed in a recess under the road surface as the sustainable actuating mechanism include a pivoting treadle plate upon which is mounted a counterweight wherein the force of gravity raises load-bearing pivoting treadle plate that spans a recess below the roadway to a slope relative to roadways and also utilizes the movement of wheels of automobiles driving over the upper surface of the angled pivoting treadle plates or flaps with hinges to drive down the treadle plates to be substantially level and flush with the roadway as kinetic power rotational energy to spin electric generators to generate electricity.

### CROSS REFERENCE TO RELATED APPLICATIONS

This application is a Continuation in Part of U.S. patent application Ser. No. 18/608,423 entitled TRAFFIC TURBINE DEVICES, SYSTEMS, AND METHODS and filed Mar. 18, 2024, which is incorporated herein by reference in its entirety. The present application also claims priority under 35 U.S.C. § 119 (e) to U.S. provisional application No. 63/604,674 filed Nov. 30, 2023, entitled ROADWAY EMBEDDED TRAFFIC TURBINE ASSEMBLIES AND METHODS, and U.S. application Ser. No. 18/186,085 (Traffic Turbine Devices, Systems and Methods) which are incorporated herein by reference in their entireties.

### FIELD OF THE INVENTION

The present disclosure relates generally to power generating turbine assemblies, systems and methods for recovering energy from moving automobile traffic.

### BACKGROUND OF THE INVENTION

Sustainability in the generation of electric power means increasing the number of emission-free power plants. turbines when needed or when the electricity rates are higher. For decarbonization, especially around population centers, diversifying with distributed energy resources is desirable.

Various systems for recovering energy from the kinetic energy of moving vehicles to generate electricity have previously been proposed. However, such systems typically have low efficiency and require high maintenance. Others cause bumpiness and vibration, which slows vehicles rather than letting them drive at speed.

Systems relying on springs to restore the pivot plates to their angled position can oppose the momentum of traffic by providing too much resistance and also require much maintenance for the many stress cycles that impact from vehicles causes. Conversely, counterweights can be finely tuned to only slightly bias the angle of pivot plates to an open position and are not subject to such stresses.

It is therefore desirable to provide an efficient pivoting treadle plate/flap plate turbine system comprised of a counterweight actuated by gravity to pivot a plate or load arm to an upward angle and depressed to a substantially horizontal position by vehicles driving over it to generate electricity, and that includes at least one prong head mounted on at least one prong attached on the underside of the pivoting plate to provide forceful impact to actuate hinged pawl-like blades mounted on the freewheel flywheel that are fixed in direction to engage with the prong head that actuates them, but movable in the opposite direction to allow the prong head to swing back up again such that the pivot plate is restored to its angled first position.

Previously known pivoting plate turbine assemblies for generating power from the wheels of moving vehicles utilize springs or air compression systems to return pivot plates to their inclined position. Drawbacks with the previously known vehicle energy generation technologies include speed bumps that cause undesirable vibration, jarring sensations and damage to the suspension systems of vehicles that travel over them at road speeds, and are therefore meant for slowing down traffic at toll plazas or near exit ramps, preventing vehicles to travel at speed. Air compressor systems include generally requiring regular maintenance, air filters and changed oil. Also, for example, systems that utilize springs to return the pivoting plates to their angled positions in opposition to the momentum of vehicles may provide unwanted resistance and loss of momentum to automobiles driving over plates actuated to an angle for vehicles to drive over. Spring-loaded treadles also require a large amount of maintenance given the many cycles actuated by automobiles and trucks; and this may impair the durability of the traffic turbine system. An arcuate-shaped arm fixed to the underside of a pivoting plate that utilizes a spring to return the plate to its inclined position can be subject to limitation in efficiency by virtue of its small arc for rotating the flywheel and by relying on a spring mechanism to impart resistance that may require a high degree of maintenance. Pressure plates may not provide sufficient stroke and also have the limitations of relying on a spring with the previously stated drawbacks. Some pinion systems that only provide force at the axle or bearing of a flywheel may not provide sufficient force relative to systems that provide more leverage by applying force farther from the axle and closer to the periphery of the flywheel.

Treadle-based systems for generating rotary energy are well known. For example, known treadle-based systems that include utilizing the engagement of treadle gears and drive gears are also subject to drawbacks including limitation by virtue of the small arc that such a treadle makes at its base. In such known treadle systems, spring-loaded treadles are forced down by tires of vehicles as they roll over such treadles and the treadle gears are disposed on the lower side of the treadle at the approach side of the treadle engage and drive drive-gears to rotate a shaft that turns a flywheel and a generator. Such treadle systems have additional drawbacks such as the limited amount of rotation of the treadle gears that engage the drive gear, the load upon the drive shaft, and the reliance on springs for many cycles that put a great deal of stress and wear on such springs, which may affect the durability of the system. Moreover, utilizing springs for moving the treadle from its lower horizontal position to its angled position puts a great deal of stress and wear on such springs. Retractive springs increase the resistance to arms or shafts and will need frequent maintenance.

Treadle-based systems that utilize the engagement of treadle gears and drive gears are subject to limitation by virtue of the small arc that such a treadle makes at its base.

In known treadle systems, spring-loaded treadles are forced down by tires of vehicles as they roll over the treadle. They can provide a large amount of resistance to motor vehicles to reduce their momentum. Moreover, utilizing springs for moving the treadle from its lower horizontal position to its angled position puts a great deal of stress and wear on such springs.

Bridges with a load-bearing deck or span that pivot about a horizontal axis that is at a right angle to the longitudinal center line of the leaf up to an open position and down to a closed position are well known. For such bascule bridges, the purpose of mounting a counterweight opposite the pivot point from the toe end of the leaf/span is to balance the span or leaf through its upward swing to allow it to be opened quickly and require little energy to operate. For such bridges, the approach end is called the “heel” and the distal outer end is called the “toe.” When the leaf pivots to the open position, the toe is actuated to an open position. Conversely, the leaf can be actuated to a horizontal closed position where the distal edge rests to be supported.

Thus a turbine device that advantageously provides low resistance to vehicles by eliminating springs and a large amount of force to actuate rotation to spin flywheels that rotate about a horizontal axis and flywheels that spin around a vertical axis from a virtually untapped source of energy is desirable.

While heavy steel flywheels rotating on a bearing about a horizontal axis are known and in common use, newer generations of flywheels utilize a magnetic levitation or permanent and electromagnetic systems to make flywheels rotating around a vertical axis without resting on physical contacts other than bearings when the magnetic field is cut off. Magnetic speed allows for high speed rotation and higher efficiency. It may be advantageous to utilize disc or cylinder flywheel devices that rotate around a vertical axis rather than horizontal axis to still use large flywheels that rotate around a vertical axis to impart rotational energy to a linked generator, and therefore require a shallower excavation. Additionally, flywheels that rotate about a vertical axis may provide additional efficiencies from magnetic levitation that does not require mechanical contact and therefore allows more energy to be imparted to spin the generator.

While the foregoing body of known systems indicates that treadle plates—including those disposed for automobiles to run over—are well known, the provision of a simple, more effective system is not previously contemplated.

Thus, systems that overcome the above-noted drawbacks are needed for generating electricity more efficiently from the kinetic energy of moving vehicles and to raise and maintain a pivoting treadle plate or pivot flap plate at a desired angle and return it to such angle after a motor vehicle has driven over it to make it unnecessary to utilize springs, motors, hydraulics or pneumatics, or to create an elevated bump in the road that is not suitable for vehicles traveling at speed on a thoroughfare are needed for recovering kinetic energy of vehicles for generating electrical energy using vehicle or traffic systems. It would be useful to have a pivot plate moved by a counterweight disposed in a recess in a roadway actuated by gravity to have its forward distal edge raised at an angle to the roadway selectively biased as is desirable beyond being level but to an extent to minimize opposition, resistance and loss of momentum to passing vehicles and also have the pivot plate depressed downward from vehicles rolling over it to drive down a forward-facing prong head mounted on the underside of the pivot plate extended to provide the full force of the impact of the mass and velocity of vehicles on the upper surface of the pivot plate to create an impact force upon blades mounted on the outside periphery of a freewheel flywheel rotating around an axis and disposed in the recess to combine the impact force of the prong head with the leverage of applying force to blades mounted fixedly in one direction and ratchet pawl-like blades on the other on the periphery of the outside circumference of a rotating freewheel flywheel, whereby when a forceful impact of the prong head swinging downward strikes such blades, they are fixed in such direction, but as the prong head swings back upward, the hinged plates provide little or no resistance for the prong head to move together with the pivoting plate upward to return the pivot plate to its first position raised to an angle to the roadway.

### SUMMARY OF THE INVENTION

The present disclosure relates generally to power generating turbine assemblies, systems and methods installed in a recess under and also on roadways. More specifically, but not exclusively, the present disclosure utilizes gravity and counterweights disposed in a recess under the road surface as the sustainable actuating mechanism to raise load-bearing pivoting treadle plates or pivot plates or flaps that span a recess below the roadway to a slope relative to roadways and also utilizes the velocity and mass of automobiles driving over the upper surface of the angled pivoting treadle plates or flaps with hinges to depress the pivoting plates to rest on a rest member substantially level and flush with the roadway as kinetic power to push down a prong head at the foremost end of a prong attached to and supported by the underside of a pivoting plate with high impact to actuate operatively linked flywheels that rotate around a vertical axis and/or rotate around a horizontal axis to spin electric generators to generate electricity.

Embodiments of the invention disclosed herein provide an improved system for generating power from the wheels of automobiles or trucks from turbine assemblies installed in recesses under roadways and on roadways using gravity actuated counterweights to raise pivot plates to an angle to the surrounding roadway and load-bearing pivot plates for automobiles to drive upon to depress the pivot plates to a horizontal position, the movement of which actuates the turbine system to spin a generator to generate electricity.

The actuation by the mass and movement by vehicles such as automobiles, vans and trucks can be imparted to a treadle mechanism or an angled flap to power a generator.

The above description sets forth rather broadly the more important features of the present invention in order that a detailed description thereof that follows may be better understood. There are additional features of the invention that will be described hereinafter, and which will form the subject matter of the claims appended hereto. This Summary is not intended to limit the scope of the claimed subject matter. It is also understood that the invention is not limited in its application to the details of the construction and to the arrangement of the components set forth in the following description of illustrated in the drawings. The invention is capable of other embodiments and of being practiced and carried out in various ways. Also, it is understood that the phraseology and terminology employed herein are for the purpose of description and should not be regarded as limiting. The accompanying drawings illustrate preferred embodiments.

The features, functions and advantages that have been discussed may be achieved independently in various embodiments of the present disclosure or may be combined in yet other embodiments.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

These, and other objects, features and advantages of this invention will become apparent from the following detailed description of the various aspects of the invention taken in conjunction with the accompanying drawings.

### BRIEF DESCRIPTION OF DRAWINGS

The accompanying drawings, which are incorporated in and constitute a part of the specification, illustrate embodiments of the invention and together with the detailed description herein, serve to explain the principles of the invention. The drawings are only for purposes of illustrating preferred embodiments and are not to be construed as limiting the invention. It is emphasized that, in accordance with the standard practice in the industry, various features are not drawn to scale. In fact, the dimensions of the various features may be arbitrarily increased or reduced for clarity of discussion. The foregoing and other objects, features and advantages of the invention are apparent from the following detailed description taken in conjunction with the accompanying drawings in which:

FIG. 1 illustrates a perspective view of a pivoting treadle plate with a counterweight mounted therecon and pivoting on a pivot point, the pivoting treadle plate angled in a slightly up position above the level of the roadway installed over a pit in a roadway with an approach side and distal forward side, in accordance with one or more aspects of the present disclosure;

FIG. 2A illustrates a side view of the pivoting treadle plate of FIG. 1 where the counterweight is pulled down by gravity and the pivoting treadle plate is mounted on the pivot point to angle the plate upwards relative to the surface of the road, in accordance with an aspect of the present disclosure;

FIG. 2B illustrates a side view of the pivoting treadle plate of FIG. 2A with the counterweight raised from the speed and weight of vehicles and a pivot point supported by a frame, while the automobile is passing over the pivoting treadle plate the pivoting treadle plate is horizontal, level and flush with the surface of the road and is resting on a rest, in accordance with an aspect of the present disclosure;

FIG. 3 illustrates a perspective view of one embodiment of a pivoting treadle plate angled slightly up above the level of the roadway installed over a pit in a roadway with an approach side and distal forward side, in accordance with an aspect of the present disclosure;

FIG. 4 is a side view of the front wheel of an automobile before engaging the pivoting treadle plate causing the pivoting treadle plate to be depressed to a horizontal position flush with the upper surface of the roadway, in accordance with an aspect of the present disclosure;

FIG. 5 is a side view of a vehicle-actuated treadle system in a first position, in accordance with an aspect of the present disclosure. The base of the substructure disposed in an excavation beneath the road supports a pinion that supports the pivoting treadle plate. The counterweight is pulled lower by the pull of gravity raising the pivoting treadle plate to an angle relative to the roadway. The downshaft mounted on and extending from the underside of the pivoting treadle plate and the Pitman arm below it are in a raised position that is not actuating movement of the crank or flywheel;

FIG. 6 is a side view of the vehicle-actuated treadle system of FIG. 5 in a second position, in accordance with an aspect of the present disclosure. The counterweight is raise, the pivoting treadle plate is horizontal flush and level with the roadway and resting on the rest. The downshaft and Pitman arm beneath it have been driven down to rotate the crank;

FIG. 7 is a partial cross-sectional, side view of the plate and turbine assembly of FIG. 5, in accordance with an aspect of the present disclosure. The downshaft is driven down by the depressing of the pivoting treadle plate downward. The Pitman arm attached at the lower distal end of the downshaft engages the crank to turn the flywheel;

FIG. 8 is cross-sectional, end view of the plate and turbine assembly of FIG. 7, in accordance with an aspect of the present disclosure. The other exemplary illustrates the downshaft, Pitman arm, crank, rotating shaft flywheel, second rotating shaft ratchet mechanism, adjacent rotating shaft with flywheel rotatingly mounted upon it and output rotating shaft to the generator;

FIG. 9 is a partial cross-sectional, side view of another plate and turbine assembly, in accordance with an aspect of the present disclosure;

FIG. 10 is a cross-sectional, end view of the plate and turbine assembly of FIG. 9, in accordance with an aspect of the present disclosure illustrates a ratchet between the rotating shaft that is rotated by the crank and the adjacent rotating shaft upon which a flywheel is rotatably mounted; and

FIG. 11 is a cross-section, side view of a hinged vehicle-actuated treadle system in a first position, in accordance with an aspect of the present disclosure.

FIG. 12 is a side view turbine assembly for generating electricity according to an embodiment of the present disclosure.

FIG. 13 is a side view turbine assembly for generating electricity according to an embodiment of the present disclosure. The turbine included in the turbine assembly of FIG. 12 is provided at an alternate angle.

FIG. 14 is a perspective view of the turbine included in the turbine assembly of FIG. 12 according to an embodiment of the present disclosure.

FIG. 15 is a is a cross-section, side view of a hinged vehicle-actuated treadle system in a first position, detailing a horizontal flywheel, in accordance with an aspect of the present disclosure.

FIG. 16 is a is a cross-section, side view of a hinged vehicle-actuated treadle system in a first position, detailing a larger horizontal flywheel, in accordance with an aspect of the present disclosure.

FIG. 17A is a perspective view of the turbine included in the turbine assembly of FIGS. 15 and 16, according to an embodiment of the present disclosure.

FIG. 17B is a perspective view of the turbine included in the turbine assembly of FIGS. 15 and 16, according to an embodiment of the present disclosure.

### DETAILED DESCRIPTION FOR CARRYING OUT THE INVENTION

Various embodiments disclosed herein relate to a road embedded pivoting plate or pivoting flap arrayed transversely across roads rotatably mounted on a pivot points or pivoting flaps, raised to an angle relative to a roadway by counterweights mounted on said plates, the counterweights actuated by gravity to raise the plate to an angle to the roadway, wherein the wheels of automobiles driving over the plate depress the plate to be horizontal and flush with the roadway surface to actuate a turbine assembly to spin a linked generator. The mechanism for actuating a coupled generator will be explained in detail below.

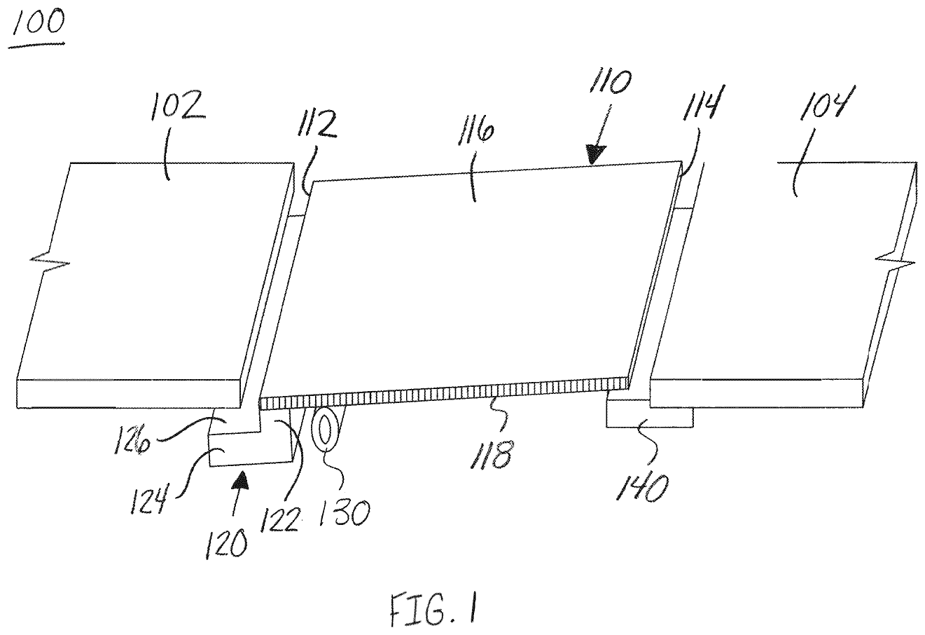

FIG. 1 illustrates an exemplary approach road surface, and distal road surface and road embedded pivoting plate turbine assembly spanning between the two road surfaces in its inclined open first position at an angle to the upper surface of the surrounding road surfaces in accordance with one or more embodiments. FIG. 1A illustrates the assembly in a second position, depressed by the vehicles of an automobile to a horizontal second position level and flush with the road surfaces. FIG. 1B illustrates the pivoting treadle plate rotatable mounted on a pivot point mounted on a structure transverse to the road, wherein on the approach side of the pivot point a counterweight is attached to the pivoting plate to provide sufficient bias to lift the pivot plate to an angle, but provide only minimal resistance and losses to the momentum of vehicles.

Referring to the drawings, wherein like reference numerals are used to indicate like or analogous components throughout the several views, and with particular reference to FIGS. there is illustrated an embodiment of a roadway and pivoting treadle system 100. The treadle system 100 includes a pivoting treadle plate or plate 110 positioned between at least two pieces of road 102, 104. The plate 110 is positioned linearly between the first piece of road 102 and the second piece of road 104. The pieces of road 102, 104 may be, for example, actual pieces of the road that have been adapted to engage with the plate 110 or additional plate pieces that engage with the actual road pieces at their exterior ends. For example, a transition plate (not shown) may be pivotally attached on one end to the roadway and on the other pivotally to the moving plate 110 to cover any gap between the approach end of the plate 110 and the adjacent roadway surface.

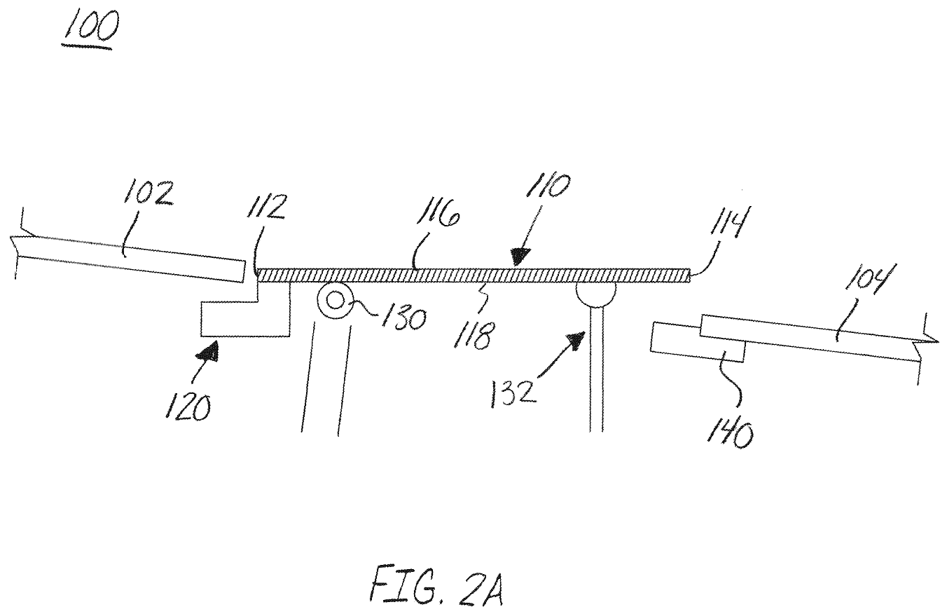

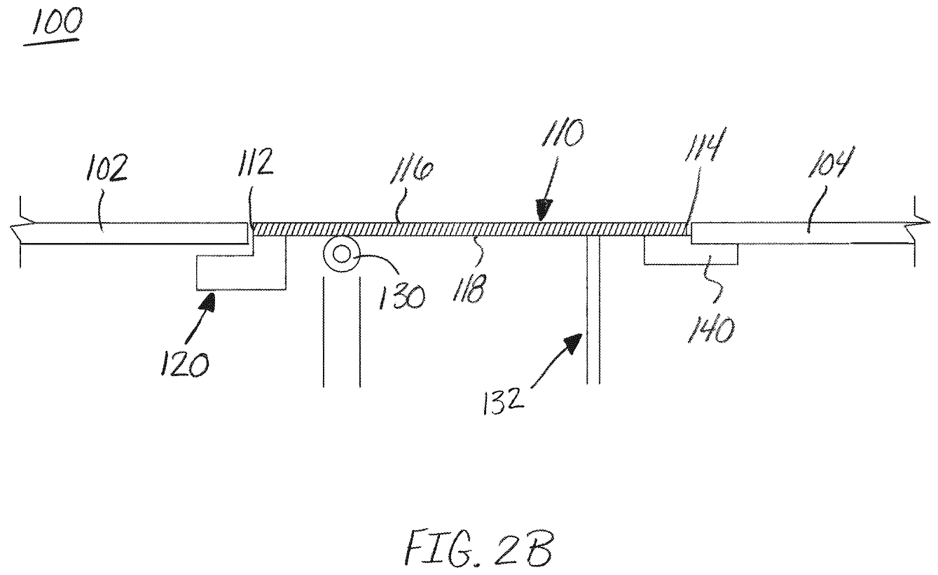

With continued reference to FIGS. 1-2B, the plate 110 includes a first end 112 and a second end 114. The first end 112 of the plate 110 is positioned adjacent to the first piece of road 102. The second end 114 of the plate 110 is positioned adjacent to the second piece of road 104. The first end 112 includes a counterweight 120 coupled to and extending from a bottom surface 118 of the first end 112. A top surface of the counterweight 120 is coupled to the bottom surface 118 of the plate 110. The counterweight 120 extends from the plate 110 to overhang past the plate 110 allowing for the counterweight 120 to be positioned under at least a portion of the first piece of road 102.

The counterweight 120 may include a first portion 122 and a second portion 124. The first portion 122 may be, for example, positioned perpendicular to or at a 90° angled relative to the second portion 124. The first portion 122 couples to and extends distally away from the plate 110. The second portion 124 couples to the first portion 122 and extends away from the first portion 122 in a direction opposite the second end 114 of the plate 110. The second portion 124 includes a top surface 126 that is positioned below the bottom surface of the first piece of road 102 both when the counterweight 120 is pulled down by gravity and when the plate 110 is being driven over. The counterweight 120 may be, for example, a single uniform piece extending along the entire width of the plate 110 or, alternatively, the counterweight 120 may be at least two pieces positioned along the first end 112 of the plate 110 and including at least a small space between each portion of the counterweight 120.

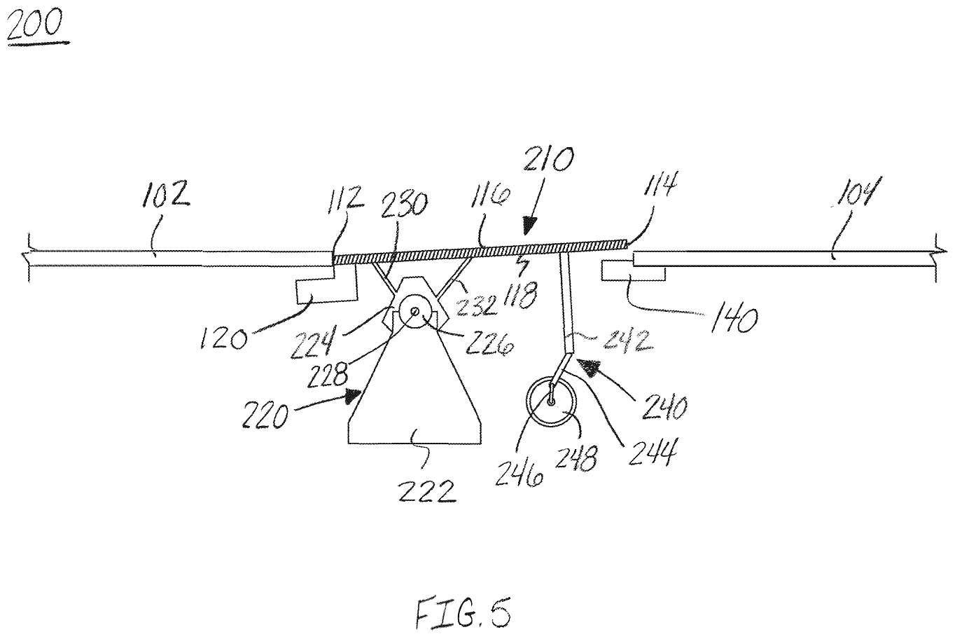

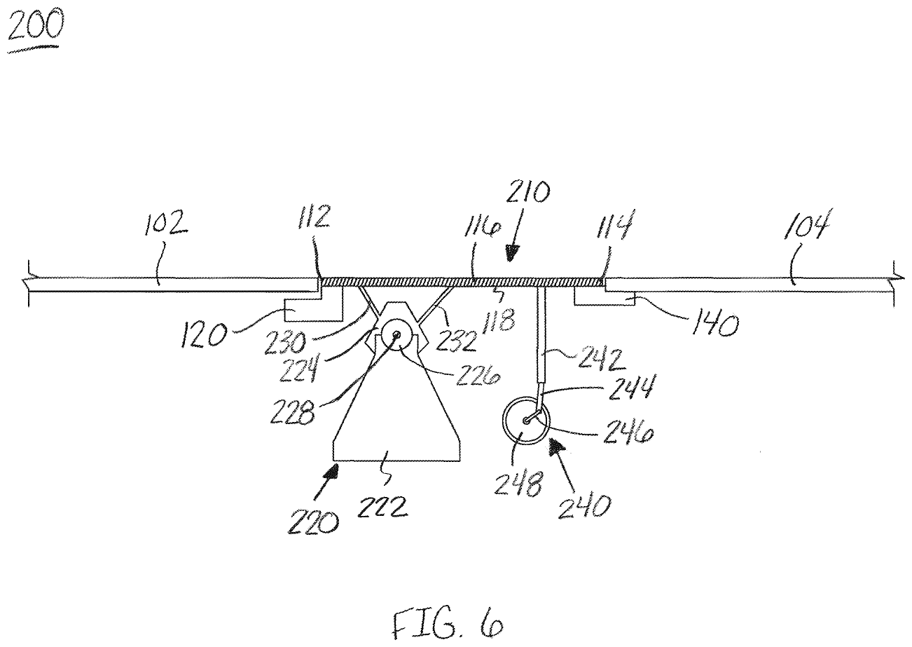

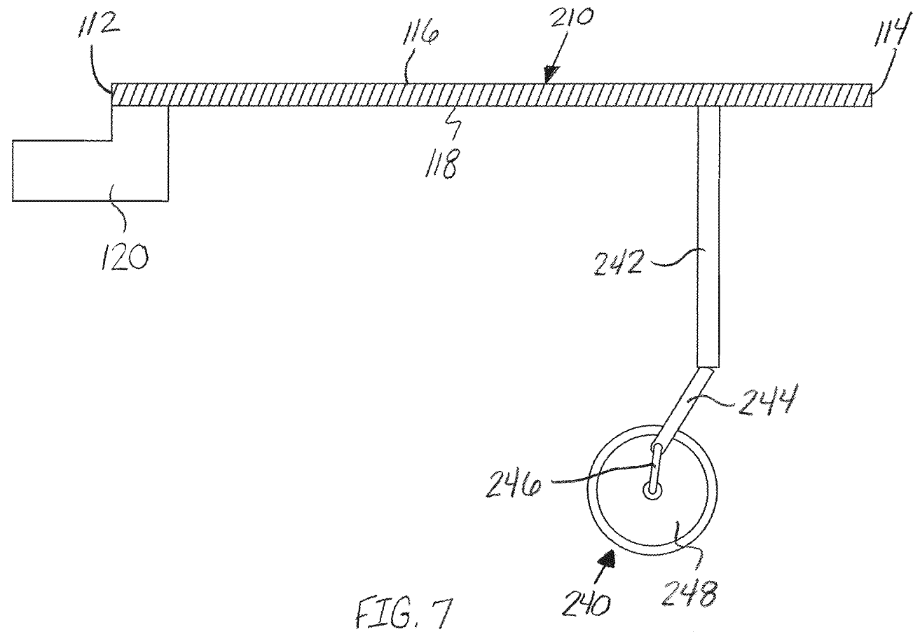

The counterweight 120 pulled down by the pull of gravity rapidly moves the pivoting treadle plate 110 or a pivot plate flap, as discussed in greater detail below, to be angled upward relative to the surface of a roadway to a first position for the wheels of automobiles and trucks to drive upon to depress to a second position to be substantially level and flush with the roadway 102, 104. The counterweight 120 bias the upward pivoting treadle plate 110 minimally to provide only slight resistance to the weight and speed of motor vehicles and thereby provide a smooth ride at speed. The counterweight 120 is described in further detail below with reference to FIGS. 5-9.

Also, as shown in FIGS. 1-2B, the plate 110 may be pivotally mounted on at least one shaft system or pivot system 130 allowing for rotation of the plate 110 relative to the rotating shaft system 130. A rotating shaft of the shaft system 130 is arrayed perpendicularly to the axis of the longitudinal axis of the pivoting treadle plate 110. The shaft system 130 may be, for example, as described in greater detail below with respect to pivot assembly 220. The shaft system 130 is mounted on and supported by a base that is part of a substructure (not shown) that is disposed in the excavation beneath the roadway. The treadle system 100 may also include a rest or rest member 140 coupled to a bottom surface of the second piece of road 104. The rest 140 may extend away from the second road piece 104 into the space below the plate 110. The rest member 140 may engage the bottom surface 118 of the plate 110 at the second end 114 to support the pivoting treadle plate 110 upon the surrounding road pieces 102, 104. The rest member 140 may be, for example, a rest, ledge, or other support member that is supported by the roadway or a substructure below the roadway. The substructure could have a surface configured to support the pivoting treadle plate or leaf 110, 210 to rest upon at its forward toe in the lowered horizontal position, as shown in FIG. 6. When the distal forward toe edge or second end 114 of the plate 110, 210 is level in the horizontal position the edge 114 rests on the member 140 to support the pivoting load bearing treadle plate 110, 210 in its horizontal position adjacent to the forward portion of the roadway.

In addition, as shown in FIGS. 2A-2B, the system 100 may include a turbine assembly or mechanism 132, which in some embodiments may be fixed or movably coupled to and extending from an underside of the plate 110. The turbine assembly 132 may be, for example, the turbine systems or mechanisms 240, 260 as described in greater detail below and which will not be described here for brevity sake.

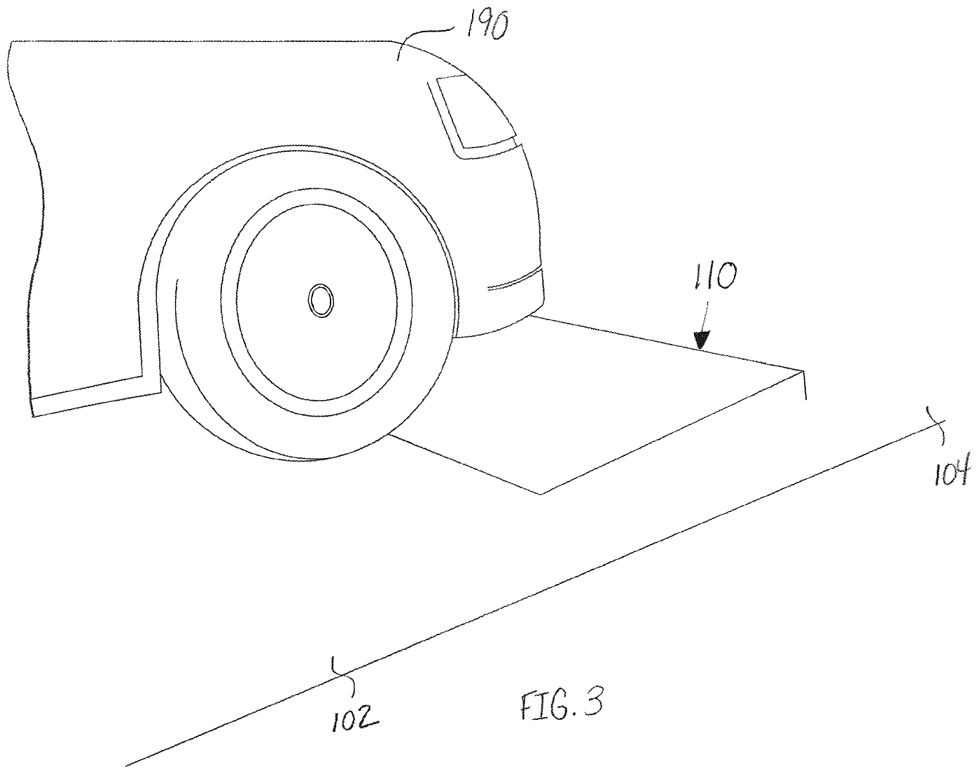

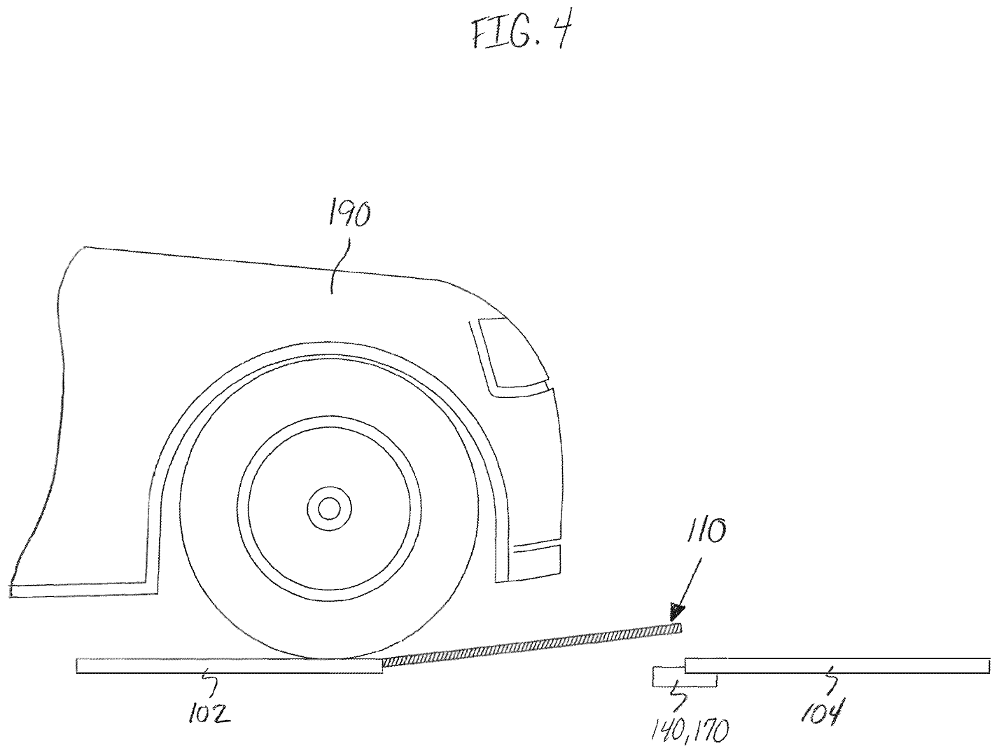

Referring now to FIGS. 3-4, an exemplary road-embedded vehicle-actuated treadle system 100 is shown as a car 190 approaches the plate 110. Below the plate 110 an excavation, recess, or pit is created to receive the downshaft 242, frame, substructure, or base of the traffic turbine system 100 and an electric power generation system, as described in greater detail below. The electric power generation system allows for kinetic energy from movement of vehicles over the plates 110 to be transformed into electricity. For example, the vehicles movement of the plates 110 may allow for rotation and driving of at least one generator, as described in greater detail below.

An angled pivoting treadle plate 110 can be adjusted to provide sufficient clearance for the undercarriage of motor vehicles and is also actuated by the driving over it to depress the distal end 114 of the plate 110 to a position that is substantially horizontal with the road surface 104. By way of illustration, pivoting treadle plate 110 or pivoting flap, described below, with a longitudinal distance of, for example, approximately thirty-six inches from it approach end to its distal forward end 114, with its distal forward end 114 raised to, for example, approximately five inches that is driven over by a vehicle 190 whose forward edge of the bumper is, for example, approximately five inches from the ground and, for example, twenty-five inches from where the front wheels come in contact with the ground would never scrape against the pivoting treadle plate 110 or pivoting flap. Similarly, when the pivoting treadle plate 110 or pivoting flap is depressed to being level with the ground, if the longitudinal distance from the approach end 112 to the forward end 114 of the plate 110 is, for example, approximately seventy-two inches, even if the forward end of the pivoting treadle plate 110 or pivoting flap is, for example, approximately ten inches, it will not scrape the bottom of the bumper or the rest of the vehicle 190, so long as it is not raised while the vehicle 190 straddles the plate 110. For many cars 190 the clearance point from the ground to the bottom of the front bumper for clearance is, for example, around 4-6 inches. If the plate or ramp 110 at its distal forward edge 114 rises higher than the bottom of a motor vehicle 190, another way to provide clearance is to make the run of the pivoting load bearing treadle plate 110 or flap plate, such as flap plate 310 as described in greater detail below, longer and/or adjust the speed at which the plate 110 pivots the load-bearing plate 110 back up to allow the vehicle 190 to pass entirely over the load-bearing plate 110 before it is raised again.

Referring now to FIGS. 5-8, a gravity counterweight and vehicle-actuated treadle system 200 is shown. The treadle system 200 is mounted on and supported by a substructure frame (not shown), which in some embodiments may include a trench box (not shown) or standalone frame (not shown). The system 200 includes a pivoting treadle plate 210 positioned between the first road piece 102 and the second road piece 104, a pivot assembly 220, and a turbine assembly or mechanism 240. The plate 210 may have a first end 112, second end 114, top surface 116, and bottom surface 118, as described above with reference to plate 110 which will not be described again here for brevity sake. The plate 210 may also include a counterweight 120 coupled to and extending from the first end 112 of the plate 210 and a rest member or member 140 coupled to and extending from the second end 114 of the plate 210. The rest member 140 is as described above with reference to plate 110 and will not be described again here for brevity sake.

With continued reference to the discussion above of the counterweight 120 with respect to plate 110, the counterweight 120 of plates 110, 210 is positioned beneath the roadway and configured for the gravitation force pulling the counterweight 120 downwards to produce an upward force upon the pivoting treadle plate 110, 210 to return the plate 110, 210 to a raised starting position. The counterweight 120 may be, for example, weighted to actuate raising and maintain the pivotally responsive plate 110, 210 to project in the open position at a desired slight angle above the upper surface of the roadway. The counterweight 120 may be fixed to the approach side 112 of the plate 110, 210 on the approach side 112 of the transverse pivot shaft 130, 226 or may be articulated to move, but in either case will allow the approach side 112 of the plate 110, 210 when it is either raised to an angle or when it is depressed to the horizontal position to be nearly adjacent with the approach side 112 of the roadway 102. Preferably, the counterweight 120 will be angled so that when it is actuated to be raised, it does not come in contact with the approach road. Thus, the plate 110, 210 may be inclined or angled from flush at a position proximate to the approach edge 112 of the plate 110, 210 to a raised position at the distal forward edge 114 of the plate 110, 210, actuated by the pull of gravity upon the counterweight 120. The counterweight 120 will be balanced with the weight of the pivoting treadle plate 110, 210 with slight bias to provide little resistance to vehicles passing over the plate 110, 210. In some embodiments, the counterweight 120 will be configured to allow for adding or reducing the weight of the counterweight 120 mounted upon and supported by the plate 110, 210. The counterweight 120 will be positioned to carry most or all of its weight on the first side or approach side 112 of the plate 110, 210 to assist with maintaining the upward angle of the plate 110, 210. The counterweight 120 is actuated to move down by gravity to actuate the plate 110, 210 by pivoting about the rotating shaft 130, 226 that is arrayed perpendicularly from the longitudinal axis of the axis of the pivoting treadle plate 110, 210. Before a vehicle passes over the plate 110, 210, the counterweight 120 is in a lower position, then once the vehicle drives onto the plate 110, 210, the counterweight 120 is raised by the weight of automobiles driving over the pivoting treadle plate 110, 210 to allow the plate 110, 210 to rotate and position the top surface of the plate 110, 210 flush with the top surface of the surround roadway 102, 104. After the vehicle leaves the plate 110, 210 and drives onto the adjacent road surface 104, the counterweight 120 is again actuated by gravity and moves causing the plate 110, 210 to raise again to its desired open angled position.

The counterweight 120 is preferably made of, for example, steel, cement, iron, tungsten or various alloys. In addition, the counterweight 120 may not be balanced and may be off center of gravity to allow gravitational force of the counterweight 120 to actuate tilting of the toe end 114 of the treadle plate 110, 210 to rise to and be maintained at the desired angle. In addition, the counterweight 120 may be adjustable and rigidly fixed to the pivoting treadle plate 110, 210. In alternative embodiments, the counterweight 120 may be linked to or articulated from the pivoting treadle plate 110, 210. As the treadle plate 110, 210 is pivoted each vehicle may engage both the counterweight 120 and the reciprocal action of the first driving flywheel 248, 268, crank 246, 266, Pitman arm 244, 264, and connecting mechanism 240, 260 that provide rotational mechanical energy to turn the first driving flywheel 248, 268. In some embodiments, the counterweight 120 may be articulated or indirectly or movably coupled to the plate 110, 210. While in other embodiments, the counterweight 120 may be rigidly mounted or directly mounted to the plate 110, 210. It is also contemplated, that the counterweight 120 may be implemented including a four bar link coupled to the lower surface of the plate 110, 210, as described in greater detail below with reference to FIG. 11. In yet another embodiment, the counterweight 120 may be mounted on a superstructure above the surface of the roadway. In some embodiments, the shaft system 130 and turbine assembly may be mounted underneath the counterweight (not shown).

With continued reference to FIGS. 5-8, the pivot assembly 220 includes a base 222 mounted on a substructure frame (not shown), a pivot member 224 movably coupled to the base 222 by a rotating shaft 226, and at least one arm 230, 232 coupled to the pivot member 224 on one end and the plate 210 on another end. The shaft 226 may rotatably engage the base 222. The shaft 226 may also include a pivot point 228 about which the shaft 226 rotates to allow for the plate 210 to pivot relative to the top surface of the surrounding road. The pivot member 224 also rotates about the pivot point 228 and also preferably in some embodiments to allow for the at least one arm 230, 232 to move the plate 210 each time a vehicle tire passes over the plate 210. The at least one arm 230, 232 may be, for example, a first arm 230 extending in a first direction from the pivot member 224 and a second arm 232 extending in a second direction from the pivot member 224. The first direction may be, for example, towards the first end 112 of the plate 210 and the second direction may be, for example, towards the second end 114 of the plate 210. Specifically, the pivoting member 224 may assist with rotating the plate 110, 210 back to a starting angled position based on the force applied by the counterweight 120.

In one embodiment, as shown in FIGS. 5-8, the turbine assembly 240 may include a drive shaft, downshaft, or connecting member 242 coupled to and extending from the underside 118 of the plate 210, and an arm or Pitman arm 244 extending from the distally lower portion of the drive shaft 242 to a crank 246. In some embodiments, the crank 246 rotates a rotating drive shaft 250 that has a mounted flywheel 248 coupled to the rotating shaft 250. The drive shaft 242 extends away from a bottom surface 118 of the plate 210, for example, perpendicular to the bottom surface 118, but may in some embodiments be movable or tiltable. The drive shaft 242 is fixedly or movably attached, for example, mounted, fastened to, or supported on, and operatively coupled to the underside or lower surface 118 of the pivoting treadle plate 210 proximate to its distal, forward side, or toe 114. The Pitman arm 244 may be coupled at a first lower distal end to the drive shaft 242 and at a second end to the crank 246. The Pitman arm 244 may be, for example, angled as it extends from the drive shaft 242. The first end of the crank 246 may extend away from a second end of the Pitman arm 244 and change angulation relative to the Pitman arm 244 during pivoting of the plate 210. The Pitman arm 244 may be, for example, configured to drive rotation of at least the flywheel 248. The second end of the crank 246 may be coupled in some embodiments to the flywheel 248 and in other embodiments to a rotating shaft 250. The crank 246 is movably attached to the Pitman arm 244 and the crank 246 actuates rotation of the first flywheel 248 or in other embodiments the rotating shaft 250 upon which is rotatably mounted a rotating flywheel 248. As shown in FIG. 5, the plate 210 is positioned in a first or ready position awaiting activation by a vehicle. Once a vehicle drives onto the plate 210, the plate 210 moves to a position flat or flush with the surrounding road, as shown in FIG. 6. As the plate 210 pivots, the movement of the turbine assembly 240 rotates the flywheel 248, which in turn creates energy for the generator either directly or through a gearbox, discussed in greater detail below. Although, the drive shaft 242 and Pitman arm 244 are shown and described as single units, it is also contemplated that the drive shaft 242 and Pitman arm 244 may be, for example, telescoping rods with struts, springs, and pistons, to lengthen the stroke of the drive shaft or a shock absorber mounted on the Pitman arm 244 to absorb shock from the arm being driven down by the plate 210.

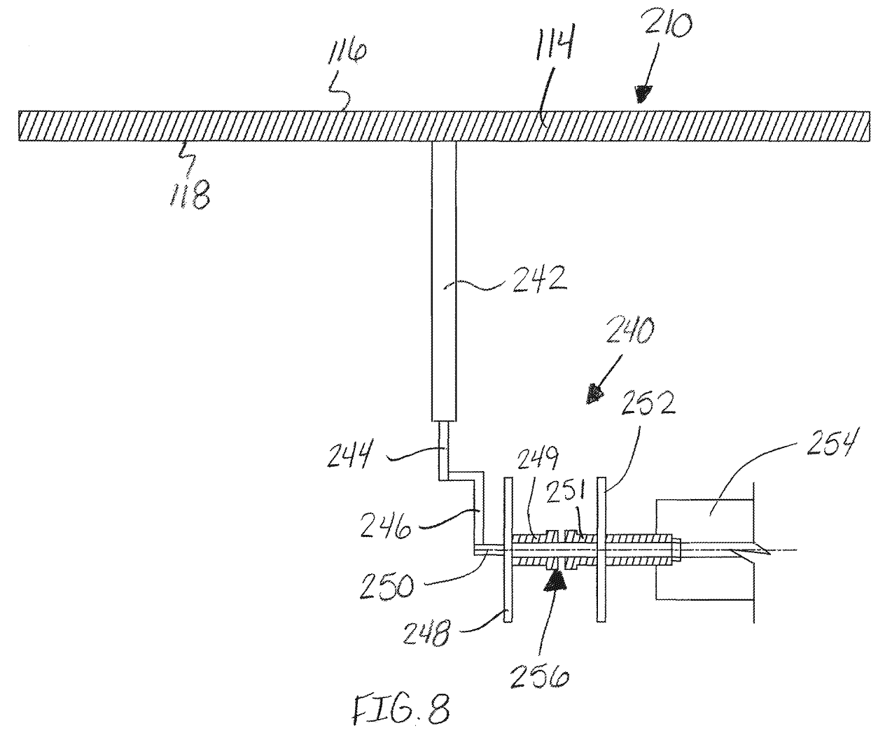

As shown in FIG. 8, the turbine assembly 240 also includes a horizontal rotating shaft 250 coupling the crank 246 to at least the flywheel 248. The flywheel 248 is mounted on the rotating shaft 250. The turbine assembly 240 also includes a freewheel flywheel or second flywheel 252 and a generator 254. The freewheel flywheel 252 is positioned spaced apart from and adjacent to the flywheel 248. The freewheel flywheel 252 is mounted on the rotating shaft 250 and is driven by the first flywheel 248 and rotating shaft 250. The freewheel flywheel 252 and flywheel 248 are operably coupled together and spaced apart by a ratchet or overriding clutch 256. The second flywheel 252 is driven using the rotating shaft 250 which is rotationally coupled to transmit rotational force, directly or indirectly, to spin a generator 254 to generate electricity. The ratchet 256 includes a first portion or driving rotating shaft 249 and a second portion or driven rotating shaft 251. The flywheel 248 is rotatably mounted to the driving rotating shaft 249. The driving rotating shaft 249 extends from the second side of the rotating shaft 250 to a directional coupling interposed between the driving rotating shaft 249 and the driven rotating shaft 251 to provide rotational force to rotate the driven rotating shaft 251 and also allow the driven rotating shaft 251 to move faster.

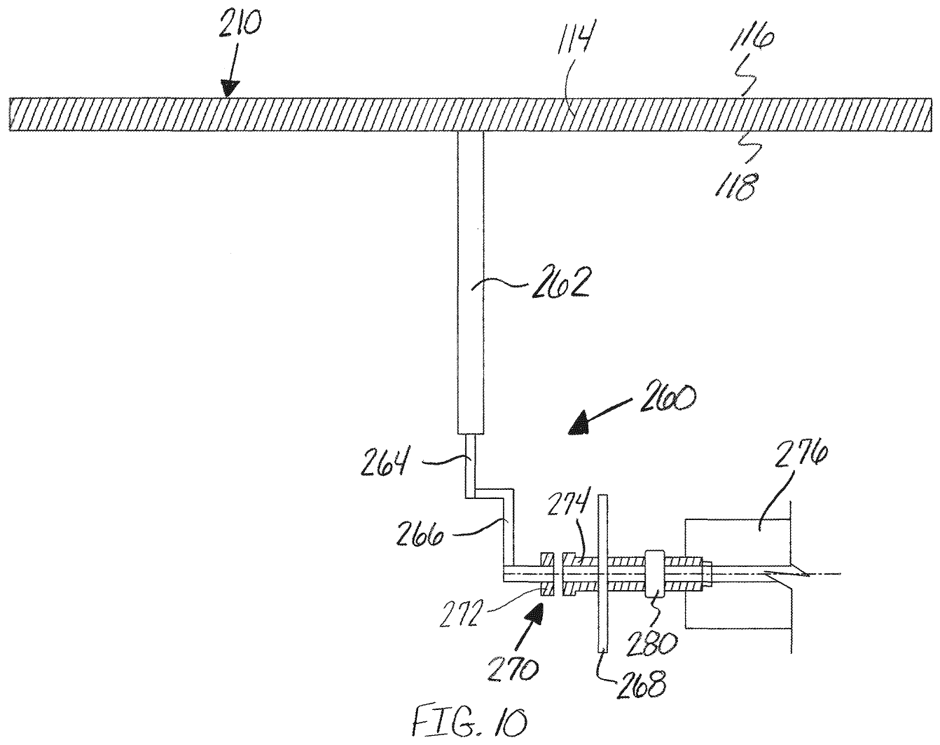

With continued reference to FIG. 8, the depressing of the treadle plate 210 drives down the drive shaft 242 that is coupled to the plate 210. As the drive shaft 242 is driven down, the Pitman arm 244 that is mounted to the drive shaft 242 is pushed downward by the force of the pivoting plate 210. The downward actuation of the operatively coupled drive shaft 242 and Pitman arm 244 at the lower end of the drive shaft 252 rotates an operatively coupled crank 246 attached to the driving flywheel 248. As the crank 246 rotates the flywheel 248, linear force is converted into rotary force and rotational movement is imparted onto the first driving flywheel 248. The flywheel 248 is rotationally mounted on a driving shaft 249 and as the rotating shaft 250 is turned by the crank 246, the rotating shaft 250 rotates and projects the rotation outwardly on the second side of the first flywheel 248. The rotating shaft 250 and flywheel 248 rotate the driving shaft 249, which in turn engages the adjacent driven shaft 251 for rotation. The driving shaft 249 and driven shaft 251 may disengage from each other to allow the driven shaft 251 to rotate freely and when the driven shaft 251 rotates fastener than the driving shaft 249. The driven shaft 251 may also continue to rotate when the driving shaft 249 is stopped. The driven shaft 251 may also be secured to the substructure. The second flywheel 252 operatively coupled to the driven shaft 251 which is operatively coupled to the driving shaft 249 to actuate rotation of the flywheel 252. The flywheel 252 is mounted to rotate with little resistance upon the driven shaft 251 and allows for the kinetic energy of the rotation of the flywheel 252 to be capable of transmitting a large torque that imparts rotation to spin a linked and operationally coupled generator 254 to generate electricity. The rotor (not shown) of the generator 254 is rotatable by depression of the plate 210 transferred via the drive shaft 242, Pitman arm 244, and crank 246 to the flywheel 248 to introduce rotational energy to drive the electrical generator 254 to produce electrical energy. In some embodiments, the operatively coupled generator will include a gearing system (gear drive system), such as gearing system 280 discussed in greater detail below in FIG. 10, interposed between the first driving flywheel 248 and the generator 254. In addition, a cable (not shown) from the generator 254 evacuates the electrical energy which can be transmitted to, for example, a grid, micro grid, industrial facility or the like, or for charging and/or storage in batteries. When necessary, the system 200 provides means for converting between AC and DC power to make it acceptable for transmission to a power grid.

In other embodiments, the rotating shaft 242 upon which the crank 246 is mounted may engage the rotating shaft 250 upon which the flywheel 248 is rotationally mounted through one or more ratchet mechanisms that enable the at least one flywheel 248 to be a freewheel flywheel to rotate independently and faster than the one or plurality of input rotating shafts 242, 250 or input crank 246. In yet other embodiments, the rotating shaft 250 between the first flywheel 248 and the rotating shaft upon which second freewheel flywheel 252 is rotatably mounted engage through a ratchet mechanism 256 to allow the second freewheel flywheel 252 to spin independently and faster than the first flywheel 248. The freewheel ratchet mechanisms 256 are mounted between adjacent driving and driven rotating shafts 249, 251 configured to allow the driven flywheel 251 to spin faster so that the freewheel flywheel 252 can continue providing speed and/or rotational torque to the adjacent driven shaft on which is rotationally mounted the freewheel flywheel 252. The ratchet 256 further allows the driven rotating shaft 251 to turn faster than the driving shaft 249 and also keep rotating when the driving shaft 249 has stopped. The adjacent driving shaft 249 and driven shaft 251 are coupled in a direction that the driving shaft 249 provides torque to the driven shaft 251, yet decouples when the driven shaft 251 rotates faster. In some embodiments, the directional coupling is in only one direction. In yet other embodiments, the rotating shaft between the first flywheel 248 and the adjacent rotating shaft upon which the second freewheel flywheel 252 is rotatably mounted engage through a ratchet mechanism 256 to allow the second freewheel flywheel 252 to spin independently and faster than the first flywheel 248. In other embodiments, the ratchet mechanism 256 is interposed between the rotating shaft 244 on which the crank 246 is rotatably mounted and adjacent rotating shaft 250 upon which the first flywheel 248 is mounted. In additional embodiments, the ratchet mechanism 256 is interposed between the adjacent rotating shaft 250 on which the first flywheel 248 is mounted and the adjacent rotating shaft upon which the freewheel flywheel 252 is mounted. In still other embodiments, the output rotating shaft between the second flywheel 252 and generator 254 spins the at least one linked generator 254 directly, while in yet other embodiments the output rotating shaft is linked to a gearbox, such as gearbox 280 discussed in greater detail below in FIG. 10, to increase or decrease the rotational the speed or force of rotation going to spin the at least one generator 254.

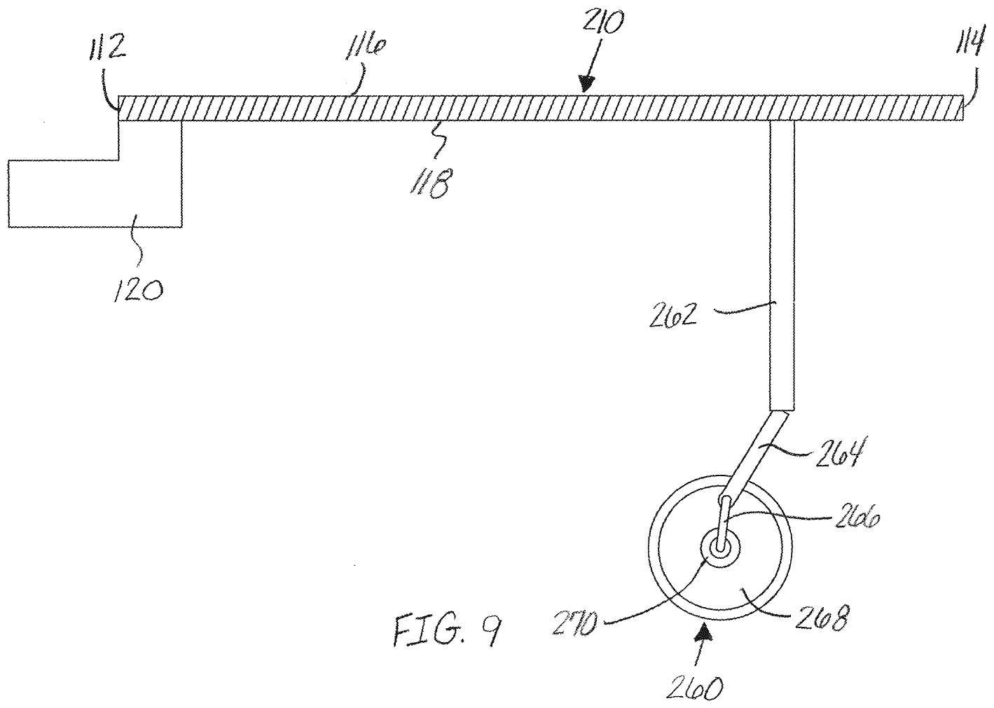

Referring now to FIGS. 9-10, an alternative turbine assembly 260 is shown. The turbine assembly 260 is coupled to and extends from the bottom surface 118 of the plate 210. The turbine assembly 260 includes a drive shaft or connecting member 262 coupled to and extending from the plate 210, a Pitman arm or arm 264 extending from the drive shaft 262 to a crank 266, and a flywheel 268 coupled to the crank 266. The drive shaft 262 extends away from a bottom surface 118 of the plate 210, for example, perpendicular to the bottom surface 118 but may in different embodiments be moveable or tiltable. The downshaft drive shaft 262 is attached, for example, mounted, fastened to, or supported on, and operatively coupled to the underside or lower surface 118 of the pivoting treadle plate 210 proximate to its distal, forward side, toc 114. The Pitman arm 264 may be coupled at a first end to the drive shaft 262 and at a second end to the crank 266. The Pitman arm 264 may be, for example, angled as it extends from the drive shaft 262. The arm 264 may be, for example, configured to drive rotation of at least the flywheel 248. The first end of the crank 266 may extend away from a second end of the Pitman arm 264 and change angulation relative to the Pitman arm 264 during pivoting of the plate 210. The second end of the crank 266 is coupled, directly or indirectly, to the flywheel 268. The turbine assembly 260 also includes a ratchet mechanism 270 positioned to engage the crank 266. Although, the drive shaft 262 and Pitman arm 264 are shown and described as single units, it is also contemplated that the drive shaft 262 and Pitman arm 264 may be, for example, telescoping rods with struts, springs, and pistons, to lengthen the stroke of the drive shaft or a shock absorber mounted on the Pitman arm 264 to absorb shock from the arm being driven down by the plate 210.

As shown in FIG. 10, the turbine assembly 260 also includes a generator 276 operably coupled to the ratchet mechanism 270. The ratchet mechanism 270 includes a first portion 272 and a second portion 274. The first portion 272 couples to the second end of the crank 266 or to the rotating shaft 250. The second portion 274 is positioned with the first end positioned and aligned with the second end of the first portion 272. The second portion 274 extends away from the first portion 272 and couples to the flywheel 268 directly or to the rotating shaft 274. The flywheel 268 may be positioned near the first end of the second portion 274. The second end of the second portion 274 engages the generator 276. The second portion 274 may, for example, directly engage the generator 276 or indirectly engage the generator 276 via a gearbox 280 or the like.

A method of using the vehicle-actuated treadle systems 100, 200 is also disclosed. The method includes positioning turbine assemblies or mechanisms 240, 260 in a recess, for example, under the road, in a median, shoulder or beside the road. After the turbine assembly 240, 260 is positioned under the roadway, a plate 110, 210 is positioned over the recess and coupled to the turbine assembly 240, 260 and a pivot system 130 or a pivot assembly 220 also positioned in the recess under the roadway. The plate 110, 210 may be made of, for example, steel, carbon fiber, aluminum or another material that can bear the load of vehicle road traffic. The counterweight 120 with assistance of the pivot system 130 or pivot assembly 220 allows the plate 110, 210 to be positioned at a slight angle relative to the top surface of the roadway and flush with the top surface of the roadway. As vehicles drive over the roadway the plate 110, 210 is actuated by the kinetic energy of the vehicles and pivots the plate 110, 210 from angled to be level or flush with the road surface. The downward movement of the plate 110, 210 from angled to level or flush with the road surface by the wheels of a vehicle transmits power to a turbine assembly 240, 260. The pivoting treadle plate 110, 210 pivots about the pivot system 130 or the rotating shaft 226 of the pivot assembly 220, respectively, moving the plate 110, 210 from an angled open position to a closed horizontal position flush with the roadway by the speed and weight of vehicles engaging the upper surface of the plate 110, 210. The pivoting of the plate 110, 210 imparts power to a shaft 242, 262 converted to impart rotary power to one or more linked flywheels 248, 252, 268 to spin a generator 254, 276 for generating electricity. After the vehicle leaves the plate 110, 210, the plate 110, 210 rotates back to the starting angled position to await another vehicle. The plate 110, 210 rotates back with the assistance of the counterweight 120 and the pivot system 130 or the pivot assembly 220.

In accordance with one or more embodiments, a method is disclosed of generating energy by moving a pivoting treadle plate 110, 210 disposed on a roadway actuated by the pull of gravity upon a counterweight 120 to pivot the pivoting treadle plate 110, 210 to be angled upwards relative to the surface of the roadway in a first position for automobiles to drive upon, and in some embodiments, method for actuation by the weight and movement of automobiles and trucks driving upon it to depress the pivoting treadle plate 110, 210 to a second position to be substantially level and flush with the roadway and also raises the counterweight 120 upward within the excavation beneath the road. The traffic turbine generator comprises a substructure disposed in a recess under a road that supports a rotating shaft 130, 226 on which a pivoting treadle plate 110, 210 is mounted and serves as the pivot point for the pivoting treadle plate 110, 210 and for the counterweight 120 actuated by the pull of gravity mounted on the first edge 112 of the pivoting treadle plate 110, 210 to angle it upward relative to the surface of the roadway in a first position for automobiles to drive upon, wherein the speed and weight of the automobiles and trucks driving upon it depresses the treadle plate 110, 210 to a second position substantially level and flush with the roadway, wherein depressing the pivoting treadle plate 110, 210 moves a downshaft 242, 262 attached to and extending downward from the underside 118 of the treadle plate 110, 210 downward, wherein at the lower end of the downshaft 242, 262 is attached a Pitman arm 244, 264 and driving the downshaft 242, 262 downward also moves the linked Pitman arm 244, 264 downward to engage a crank 246, 266 to move the crank 246, 266 in a rotational motion to rotate rotating shafts 250, one or a plurality of flywheels 248, 252, 268 rotatable mounted on rotating shafts 250, and in embodiments utilizing on or a plurality of ratchet mechanisms 256, 270 and in some embodiments, one or a plurality of freewheel flywheels 252, 268 to rotate independently and faster, and in other embodiments output shafts and/or a gearbox 280 to impart rotational movement to spin a linked generator 254, 276. The method comprises the steps of the pull of gravity actuating the pivoting treadle plate 110, 210 to pivot upwards, the speed and weight of vehicles depressing the pivoting treadle plate 110, 210 from the angled position to a horizontal position such that a downshaft 242, 262 with an attached Pitman arm 244, 264 is extended downward and the Pitman arm 242, 262 engages the crank 246, 266 to move in a rotational movement to rotate rotational shafts 250 upon at least one flywheel 248, 252, 268 is attached, wherein the rotation of the rotational shafts 250 may be direct or by utilizing ratchets 256, 270 that power a freewheel flywheel 252, 268 to spin independently and/or faster than the rotational speed of the preceding rotating shaft 250 or in certain embodiments, of the preceding flywheel 248, wherein the output shaft extending from the freewheel flywheel 252, 268 rotates to cither directly or through a gearbox 280 spin a linked generator 254, 276.

Although the above method is described with only one plate 110, 210, it is understood that one or a plurality of plates 110, 210 may be disposed across the surface of one or more lanes of a roadway over one or more pits underneath the roadway. In addition, the turbine mechanism 240, 260 may include one or more drive shafts 242, 262 and Pitman arms 244, 264.

Additionally, one or a plurality of generators 254, 276 may be utilized, either individually or connected by electrical transmission lines. Further, although only a single system 100, 200 is disclosed in the above method, the systems 100, 200 may include, for example, one standalone system 100, 200 or a plurality of mechanically or electrically connected systems 100, 200.

As shown in FIGS. 1-4, the roadway surrounding the plate 110, 210 may include a near approach side where the vehicles approach the plate 110, 210 to engage it. The roadway surrounding the plate 110, 210 may also include a distal forward far side of the roadway to where the vehicles move after they pass over the treadle system 100, 200. The recess, pit or excavation positioned in the ground below the plate 110, 210 contains vertical sides sufficient to contain the mechanisms, assemblies, framework and structure of the power generation system including the pivot system 130 or pivot assembly 220 and the turbine assembly 240, 260. The recess also includes columns and footings to carry the load of the pivot system 130 or pivot assembly 220, turbine assembly 240, 260 and plate 110, 210. The horizontal rotating shaft 250 of the turbine assembly 240 may be positioned, for example, proximate to the approach end of the roadway and transversely across at least one lane under the roadway at an axis perpendicular to the longitudinal center line of the roadway.

Referring now to FIG. 11, another pivoting treadle plate system 300 is shown. The system 300 includes a plate or flap 310 positioned between a first road piece 302 and a second road piece 304. The system 300 also includes a counterweight system 320 coupled to and extending from the bottom surface 318 of the plate 310. The system 300 may include a turbine assembly or mechanism 260 coupled to and extending from an underside of the plate 310 and generator 276, as discussed in greater detail above and which will not be described again here for brevity sake. The system 300 further includes a hinge member 340 coupling the first end 312 of the plate 310 to the first road piece 302 on the approach side of the roadway. The hinge member 340 allows for the plate 310 to angle relative to the first road piece 302 when gravity is applied to the counterweight 320. When a vehicle drives over the plate 310, the hinge member 340 allows the top surface 316 of the plate 310 to rotate to be flush with the top surface of the surrounding roadway 302, 304 due to the weight of the vehicle. After the vehicle leaves the plate 310, the second end 314 of the plate 310 will move away from the second road piece 304 as gravity is once again exerted upon the counterweight system 320 and the first end 312 of the plate 310 will rotate about the hinge member 340 returning the plate 310 to a first angled position.

The counterweight system 320 may include, for example, a four bar arrangement 322, 324, 326, 328 and a counterweight 330. The four bar arrangement includes a first bar 322 with a first end coupled to and extending from an underside of the flap 310, a second bar 324 with a first end hingedly or rotatably coupled to a second end of the first bar 322, a third bar 326 with a first end hingedly or rotatably coupled to a second end of the second bar 324, and a fourth bar 328 coupled to and extending from an underside or bottom surface of a support member 350 positioned beneath the first road portion 302. The third bar 326 may be, for example, hingedly or rotatably coupled between the first end and the second end to the fourth bar 328. The counterweight 330 may be coupled to the second end of the third bar 326. The counterweight 330 raises a toe end 314 of the flap 310 when gravity is applied, then once a car drives over the flap 310, the counterweight 330 is raised thereby lowering the flap 310 and allowing for the turbine mechanism, such as turbine mechanisms 240, 260, to be activated and energy generated.

The flap 310 may be, for example, one flap 310 across the entire approach end of the pit or a plurality of flaps 310 spaced apart along the approach end 312 of the treadle system 300. The flap 310 may include a heel flap that extends from the upper road surface and the distal forward end of the flap 310 may be raised to a desired incline angle by the use of a counterweight system 320.

In another embodiment, the horizontal rotating shaft 250 of the turbine assembly 240 may be, for example, rotationally attached to a slab of pavement proximate to the approach pivotally mounted and supported upon the horizontal transverse pivot shaft for support or pivoting.

In addition, in another alternative embodiment, a drive shaft may be attached proximate to the underside of the counterweight 120. The drive shaft may be linked to and responsive to raising the treadle plate to its angled position by the downward movement of the counterweight 120, wherein when vehicles pass beyond the treadle plate 110, 210 and gravity actuates the counterweight 120 to be driven downward to cause an upward pivot of the treadle plate 110, 210, the driving shaft or arm beneath the counterweight 120 is driven downward to actuate a second drive shaft to cause a Pitman arm to rotate a flywheel. The system may include drive shafts both at underside of toe end of treadle plate 110, 210 and underside of counterweight 120, wherein on the lower or distal end of the drive shaft or arm is configured an attached Pitman arm configured to drive rotation of a rotating crank attached to a first driving flywheel about a rotational axle.

It is also contemplated that the distal forward toe end of the plate 110, 210, 310 may include or be configured with a lock or locking mechanism to secure the plate 110, 210, 310 in a horizontal close position, for example, when there is snow or rain. In alternative embodiments, the recess or pit may be reinforced with concrete walls, trenchbox, frame, or shield to protect the turbine mechanism 240, 260 from water, snow, dust, mud and prevent cave-ins. Alternatively, the turbine mechanism 240, 260 may be completely sealed in a housing for weather protection.

Further, the plate 110, 210, 310 may include a brake mechanism (not shown) that may control the desired slope or angle that the plate 110, 210, 310 pivots to when in use. The brake mechanism may, for example, limit upward motion of the plate 110, 210, 310. The brake mechanism may be, for example, a chain, rope, rod, linkage, or the like. In addition, the slope desired angle or height of the distal toe end of the plate 110, 210, 310 may be adjustable. In yet another embodiment, the time it takes for raising the plate 110, 210, 310 upward may be adjusted by means of a governor or controller (not shown).

In some embodiments, a supplementary plate or some other exemplary resilient covering movably attached and engaging the first edge or second edge of the plates 110, 210, 310 and overlapping the road surface can be utilized to provide smooth transition from the road surfaces onto the pivoting treadle plate 110, 210, 310 or the pivoting plate and may also be utilized in embodiments to provide desired further weather protection.

In order to prevent vehicle damage during use of the systems 100, 200, 300, known traffic signs may be used. Such as, lane markers or cones to show that drivers are prohibited from changing to such marked lanes. Examples include double yellow lines and markers that certain lanes are strictly for high occupancy vehicles or buses. This would prevent automobiles from attempting to change lanes into a raised plate 100, 210, 310. In addition, exit ramps frequently have only one lane and are therefore not subject to lane changing.

It is also contemplated that cameras or sensors may be arrayed at each generator assembly to detect vehicles to make adjustments to the rise of the distal side of the plate 110, 210, 310 or to provide compensation to the drivers of vehicles for using the lane with the generator assembly to generate power.

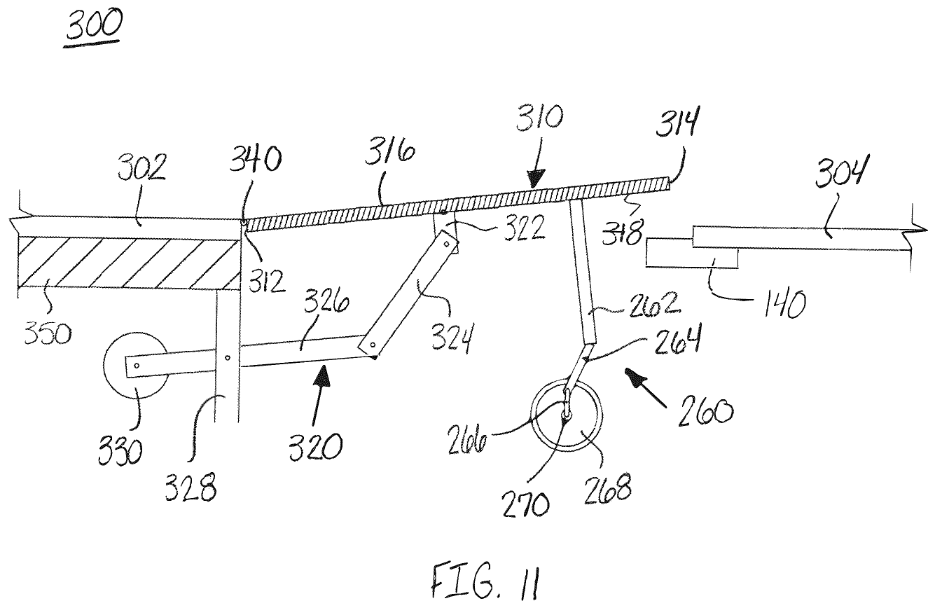

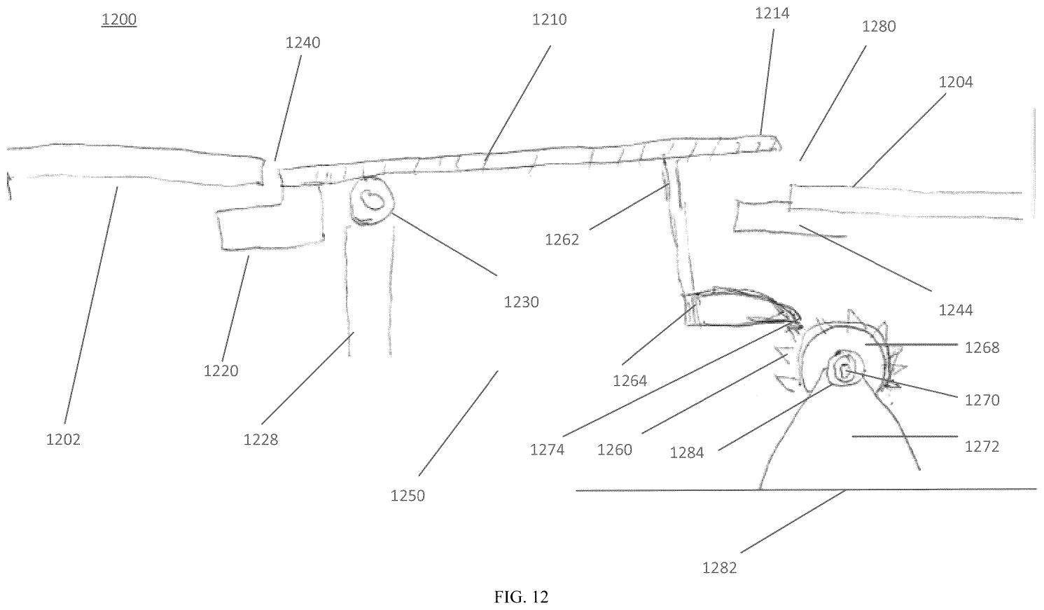

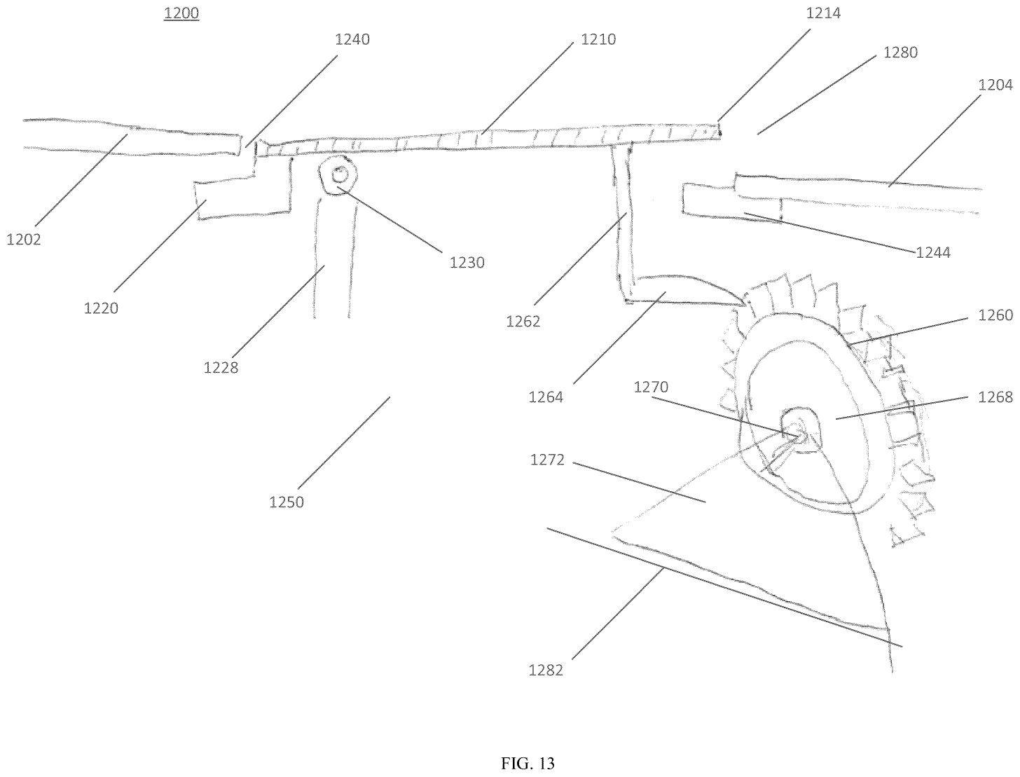

Referring to FIGS. 12-14, embodiments of the present disclosure include turbine assemblies and methods, such as turbine assembly 1200, in accordance with one or more embodiments for generating electricity with minimal environmental impact from the actuation by gravity of the movement of a counterweight 1220 attached to the approach end of a pivoting or hinged plate 1210 or an arm 1210 to raise the plate 1210 or arm 1210 to a raised angled position relative to the surface of a roadway 1202, 1204. The kinetic energy generated by automobiles moving on roadways that depress the plate 1210 or load arm 1210 to be level or flush with the roadway 1202, 1204 may thereby drive down a lower prong mounted and supported on the underside pivot plate 1210, hinged plate 1210 or load arm 1210, at least one prong extending longitudinally in the same axis as the plate 1210 or load arm 1210 at least to the distal forward edge of the plate 1210 or arm 1210, mounted to which at the forwardmost distal end is a prong head of desired mass. In embodiments, the prong and head preferably extend longitudinally farther than the plate 1210 or load arm 1210 to engage a flywheel 1268 to rotate it to spin an operationally coupled generator 1272 to generate electricity.

In some embodiments, the turbine assembly 1200 includes a turbine assembly for spinning a coupled generator 1272. A supporting structure/frame/substructure 1282 may be disposed in a recess 1250 excavated underneath a roadway 1202, 1204 for mounting the turbine assembly 1200 thereon for support, disposed both underneath a roadway 1202, 1204 and also on the roadway 1202, 1204. A housing (not shown) may be included to protect the turbine assembly 1200 and generator 1272.

In embodiments, a pivoting plate 1210 or pivoting load arm 1210 may be pivotally mounted on and supported by a pivot point shaft 1262 mounted transversely across the roadway 1202, 1204, transverse to the center axis of the pivoting plate 1210. In alternative embodiments, a load arm 1210 or upward tilting/swinging hinged plate 1210 or load arm 1210 mounted on a hinge 1240 that is transverse to the center axis of the hinged plate 1210.

In embodiments, the pivoting plate 1210 or pivoting load arm 1210 pivot point or hinged load with an upper load-bearing surface can withstand impact forces, arrayed in a roadway 1202, 1204 transversely to the longitudinal flow of vehicle movement for high traffic roadways. The pivoting plate or load arm or hinged plate may be actuated preferably by a sustainable, gravity-actuated counterweight 1220 mounted to the plate 1210 or load arm 1210 at the approach end of the plate 1210 or load arm 1210 to tilt upward the plate 1210 or load arm 1210 that span the recess to a raised angled first position relative to the surface of the roadway 1202, 1204 to be open at its distal forward edge opposite the pivot 1230 or hinge 1240 to a first position, or actuated by kinetic energy to swing downward to a horizontal closed second position lying flat and level with the roadway 1202, 1204 when in a closed position.

In embodiments, a means may be included for tilting the pivoting plate 1210, hinged plate 1210 or load arm 1210 to an open first position 1280 to a desired angle to its surrounding road surfaces and a means may be included for depressing the pivoting plate 1210, hinged plate 1210 or load arm 1210 to a closed level horizontal second position. The preferred but not exclusive means for tilting the plate 1210 or load arm 1210 upward may be a counterweight 1220 attached to the pivoting plate 1210 or load arm 1210 prior to the transverse pivoting shaft pivot point 1230, and for the pivoting plate 1210, hinged plate 1210 or load arm 1210 at the heel approach edge of the pivoting plate 1210. The counterweight 1220 may be actuated by the pull of gravity upon the counterweight 1220 to move the counterweight 1220 downward in the recess 1250 beneath the roadway 1202, 1204 as a sustainable gravity actuated mechanism. This may thereby actuate the pivoting plate 1210, hinged plate 1210 or load arm 1210 to tilt upward from the approach edge opposite from the distal forward toe edge to raise the forward distal toe edge 1214 upward to its open first position 1280 relative to the surface of the roadway 1202, 1204, actuated by gravity.

In embodiments, the pivoting plate 1210, hinged plate 1210 and load arm 1210 may be load bearing and have an upper load-bearing surface 1210a and an underside 1210b. The mass and velocity of automobiles driving on the road upon the plate 1210 or load arm 1210 may thereby drive a system for depressing a pivoting plate 1210, hinged plate 1210 or load arm 1210 to drive it downward from its first angled position relative to the surrounding roadway surface 1202, 1204 to move it to a second horizontal closed position level with the roadway 1202, 1204 and resting on a rest ledge 1244. The movement of vehicles may be the kinetic power drive system to move the plate 1210 or load arm 1210 downward and the counterweight 1220 upward in the recess 1250.

In embodiments, when a vehicle passes beyond the plate 1210 or load arm 1210 back onto the roadway surface 1202, 1204, the pull of gravity again may pull down the counterweight 1220 to actuate the tilting of the plate 1210 or load arm 1210 back to its angled first position 1280. The counterweight 1220 attached at the approach end of the pivoting plate 1210, hinged plate 1210 or load arm 1210 and additional elements may be configured to be sufficiently biased to lift the plate 1210 or load arm 1210 to a desired angle relative to the roadway surface 1202, 1204 and also biased against the weight of the plate 1210 or load arm 1210 to provide little or no resistance to or loss of momentum to the automobiles driving over it to depress the plate 1210 or load arm 1210 to its second horizontal position.

In embodiments, at least one longitudinally forward-facing lower prong 1262 may be fixedly attached to and supported by the underside of the pivot plate 1210, hinged plate 1210 or load arm 1210. Prong 1262 may extend longitudinally at least to the distal forward toe edge 1214 of the plate 1210 or load arm 1210 or in embodiments preferably the lower prong 1262 projecting longitudinally forward beyond the forward edge of the plate 1210 or load arm 1210, the lower prong 1262 positioned underneath the plate 1210 or load arm 1210 so that when the pivot plate 1210, hinged plate 1210 or load arm 1210 is in its raised position 1280, the lower prong is raised with it. However, it may remain below the level of the street and does not contact any surface at or underneath the substructure 1282 disposed in the recess 1250 or the underside of the road surface 1202, 1204.

In embodiments, fixedly mounted to and supported by the at least one forward-facing lower prong 1262 at its forwardmost distal edge 1214 may be a prong head 1264 comprised of a load of desirable mass to impart efficient impact force. A freewheel flywheel 1270 with a hub 1268, either solid disc or with spokes may be disposed between the center of the wheel 1270 and the rim and an outer circumference rim on both sides at the periphery. The freewheel flywheel 1270 may be mounted at its hub 1268 on the bearing/rotating shaft 1284 that rotates about a horizontal axle 1274 supported by the structure. The shaft 1284 may be mounted transversely upon the substructure 1282 disposed in a recess 1250 beneath the roadway 1202, 1204. The freewheel 1270 may be mounted on the substructure 1282 so that it is located within easy striking distance by the prong head 1264 upon the blade, tooth or pawl mounted that form the circumferential outer periphery 1260 of the freewheel flywheel 1270.

In embodiments, when the pivoting plate 1210 may be mounted on the pivot point 1230, or load arm 1210 mounted on the pivot point 1230, or hinged plate 1210 are driven down by the mass and velocity of vehicles driving over their upper surface, they actuate the coupled lower prong 1262 and the distal end of the lower prong head 1264 to swing downward to engage with and transmit an impact force upon the upper surfaces of the spring equipped adjacent blade, tooth or pawl mounted on the outer surface 1260 of the circumference at the periphery of the freewheel flywheel 1270. This may transfer impact force to efficiently actuate rotation of the freewheel flywheel 1270.

In embodiments, a freewheel flywheel 1270 may include spring-equipped blades, teeth or pawls mounted on the outside surface 1260 of the outer periphery of the circumference of the freewheel flywheel 1270 between the left lip and the right lip and spaced from each other. The flywheel 1270 may be mounted at an angle to provide an upper surface that faces opposite to the direction that is desired for the freewheel flywheel 1270 to rotate for efficiently engaging with a prong head 1264 of the lower prong 1262 that transfers the force to the blade, tooth or pawl to rotate the freewheel flywheel 1270. The upper surface 1260 of the blade, tooth or pawl to which the prong head 1264 at the end of the prong 1262 employs downward force against the blade, tooth or pawl to forced it down may be configured to impart maximum force (torque) in one direction to rotate the wheel 1270 in the desired direction.

In embodiments, the freewheel flywheel 1270 may include spring equipped blades, teeth or pawls are mounted on and supported by the circumferential outer surface 1260 of the freewheel flywheel 1270 to be locked rigidly to prevent them from moving in a downward direction when force is imparted by the prong head 1264. This may allow them to move unrestrictedly in the upward direction to allow the prong head 1262, lower prong 1264, plate 1210 or load arm 1210 to move back upward up, such that the prong head 1264 and prong 1262 swing up past the blades, teeth or pawls mounted upon the freewheel flywheel 1270 to provide little or no resistance and/or opposition and allow the plate 1210 or load arm 1210 to be restored to the inclined first position 1280.

In some embodiments, cushioning material may be affixed to the upper side and underside of the prong head 1264 to protect the prong head, blades, teeth or pawl elements mounted on the freewheel flywheel 1270 with which the prong head 1264 operatively engages. In certain embodiments, the rotating horizontal shaft 1284 upon which the freewheel flywheel 1270 is mounted extends to engage and provide rotational energy to a connected horizontal shaft (not shown) of a coupled generator 1272 to generate electrical energy.

In some embodiments, a second freewheel flywheel rotates around a vertical axis. In these embodiments, the second freewheel flywheel may include a disc turbine-generator system. Rotation of the second freewheel flywheel may provide rotational force to spin the disc turbine generator, such as 1272. In some embodiments, the second freewheel flywheel comprises a disc turbine-generator system. Rotation of the second freewheel flywheel may impart rotational force to spin the cylindrical turbine generator, such as 1272.

In some embodiments, additional linkages may be included between the freewheel flywheel 1270 that rotates about a horizontal axis to transmit rotational energy to an operatively coupled freewheel flywheel 1270 that rotates about a vertical shaft utilizing a gear train transmission to engage to rotate and transmit torque to the coupled flywheel 1270 rotating about the vertical axis.

In some embodiments, on each of the left side and right side of the circular circumferential periphery 1260 of the freewheel flywheel 1270 rotating about the horizontal axis is mounted a rim, such as outer surface 1260. The rim may also be comprised of a protruding lip with outside side surface, an interior surface and outer edge surface facing the prong 1262/1264 for the purpose of efficiently transferring torque from the rotation of the freewheel flywheel 1270 that rotates about a horizontal axis so that its rotational motion results in efficient rotation of the engaged freewheel flywheel 1270 that rotates about a vertical axis at low or high speeds.

In some embodiments, mounted fixedly for the freewheel flywheel 1270 that rotates about a horizontal axis on the outside surface 1260 of the rim facing the prong 1262/1264 are fixedly mounted gear teeth for the purpose of transferring torque to an arcuate rack arrayed on the upper surface 1260 of the outside circumferential rim of a freewheel flywheel 1270 that rotates about a vertical axis. Fixedly mounted gear teeth may be mounted fixedly on at least one outside side surface 1260 of the rim. Fixedly mounted bevel gearing teeth for directly transmitting torque from the freewheel flywheel 1270 that rotates about the horizontal axis to the freewheel flywheel 1270 that rotates about the vertical axis may alternatively and/or also be mounted fixedly on at least one outside side surface 1260 of the rim.

In embodiments, mounted on and supported by the underside of the counterweight 1220 may be a moving downshaft (not shown), operatively coupled on its upper end with the counterweight 1220 so that when the counterweight 1220 moves up actuated by the movement of vehicles onto the plate 1210 or load arm 1210, the coupled moving downshaft also moves up and conversely when the coupled counterweight is pulled down by gravity, the coupled downshaft also moves downward. The moving downshaft may be configured with a rack of gear teeth that run along its shaft. The gear teeth of the moving downshaft may engage an operatively coupled first pinion. The operatively coupled first pinion may be mounted on a first rotatable horizontal shaft. The first horizontal rotatable shaft may be rotatably mounted on a bearing that is mounted on the substructure 1282.

In some embodiments, a second horizontal rotatably mounted rotatable shaft (not shown) may be adjacent to the first horizontal rotatably mounted shaft mounted on a bearing (not shown). The bearing may also be mounted on the substructure 1282 and turn about the same horizontal axis as the first horizontal rotatably mounted shaft, which has interposed between them a ratchet type mechanism (not shown) that rotationally drives the second horizontal shaft to rotate in one direction at different speeds than the first horizontal rotatably mounted shaft and also keep rotating when the first horizontal shaft is stopped.

At the distal end of the second horizontal rotatably mounted shaft, opposite to position of the first pinion, may be mounted a second pinion (not shown) for transmitting rotational torque to the second freewheel flywheel that rotates about the vertical axis. In embodiments, the second freewheel flywheel that rotates upon a vertical axis may be provided with teeth on its upper surface or lower surface around the peripheral circumference. The teeth on the upper or lower surface may comprise an arcuate rack for accepting the torque of the second pinion to actuate rotation of the second freewheel flywheel. The downshaft, first pinion, first horizontal shaft, ratchet mechanism, second horizontal shaft and second pinion may thereby engage with the teeth of the arcuate rack mounted upon the second freewheel flywheel to comprise a second force input to provide torque to rotate the freewheel flywheel 1270 that rotates about a vertical axis.

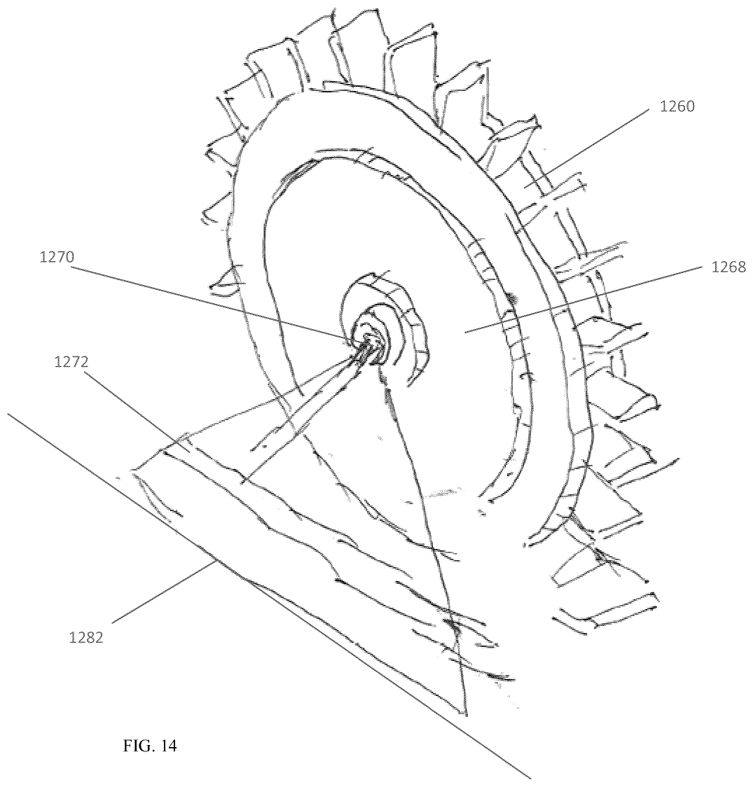

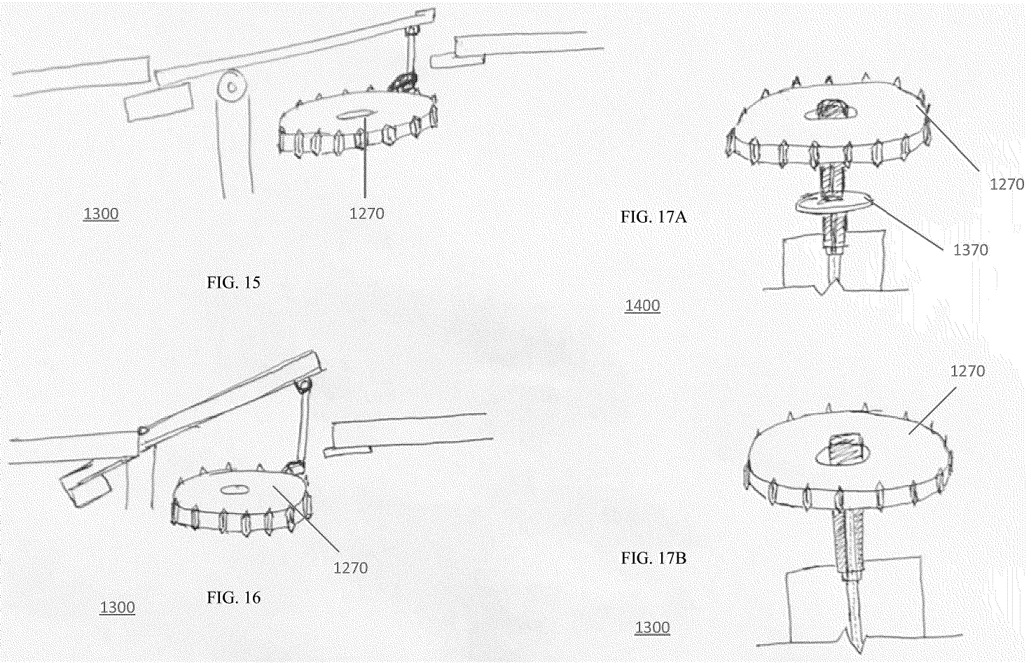

FIGS. 15-17B further include embodiments of the present disclosure include turbine assemblies and methods, such as turbine assembly 1300, in accordance with one or more embodiments for generating electricity with minimal environmental impact from the actuation by gravity of the movement of a counterweight 1220 attached to the approach end of a pivoting or hinged plate 1210 or an arm 1210 to raise the plate 1210 or arm 1210 to a raised angled position relative to the surface of a roadway 1202, 1204. These embodiments include a horizontal freewheel flywheel 1270. In FIG. 16, the pivot/hinge area can include an assembly which provides space under the treadle plate 1210 for a wheel 1270 with a larger radius, increasing energy output. In embodiments, the treadle may attach to the arm with the prong, which can allow the shaft to be vertical. In FIG. 17A, the wheel to an optional smaller flywheel 1370 may be included in assembly 1400. FIG. 17B is similar to FIG. 17A, but without the additional flywheel 1370, as different environments may include different efficiency requirements. A generator, and other components related to previous embodiments, may similarly be present here as well.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The invention has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the invention be construed as including all such modifications and alterations. In particular, acts, elements and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting.

Having thus described the preferred embodiments, the invention is now claimed to be:

1. A gravity-actuated and vehicle-actuated treadle system for generating electric power.

2. The vehicle-actuated treadle system of claim 1, wherein the at least one turbine assembly comprises:
shaft attached to a second end of the crank.

3. The vehicle-actuated treadle system of claim 2, wherein the crank is coupled directly to a first flywheel of the at least one flywheel.

4. The vehicle-actuated treadle system of claim 2, wherein the at least one flywheel comprises:
a first flywheel coupled to a rotating shaft attached to the second end of the crank; and
a second flywheel mounted on a rotating shaft spaced apart from the first flywheel.

5. The vehicle-actuated treadle system of claim 4, wherein the at least one turbine assembly further comprises:
a rotating shaft coupled to the crank on a first end and the first flywheel on a second end; and
a generator rotated to spin by at least the first flywheel.

6. The vehicle-actuated treadle system of claim 5, wherein the at least one turbine assembly further comprises:
a ratchet interposed between and coupled to adjacent horizontal shafts on which are mounted the first flywheel and the second flywheel.

7. The vehicle-actuated treadle system of claim 6, wherein the ratchet comprises:
a driving rotating shaft coupled to the rotating shaft on a first end; and
a driven rotating shaft engaging the driving rotating shaft on a first end and the generator on a second end.

8. The vehicle-actuated treadle system of claim 7, wherein the first flywheel is coupled to the driving rotating shaft and wherein the second freewheel flywheel is coupled to the driven rotating shaft.

9. The vehicle-actuated treadle system of claim 2, wherein the at least one turbine assembly comprises:

10. The vehicle-actuated treadle system of claim 9, wherein the at least one turbine assembly further comprises:
a ratchet mechanism coupled to and configured between the crank on a first end and a generator on a second end.

11. The vehicle-actuated treadle system of claim 10, wherein the ratchet mechanism comprises:
a first portion coupled to the second end of the crank; and
a second portion rotatably engaging the first portion.

12. The vehicle-actuated treadle system of claim 11, wherein the flywheel couples to the second portion of the ratchet mechanism.

13. The vehicle-actuated treadle system of claim 2, wherein the pivot assembly comprises:
a base;
a shaft rotatably coupled to the base;
a pivoting member coupled to the shaft; and
at least one arm extends from the pivoting member and engaging the plate.

14. The system of claim 13, wherein the at least one turbine assembly comprises:
a drive shaft with a first end and a second end, wherein the first end coupled to the plate;
a Pitman arm with a first end and a second end, wherein the first end of the Pitman arm is coupled to the second end of the drive shaft;
a crank with a first end and a second end, wherein the first end of the crank is coupled to the second end of the Pitman arm;
a rotating shaft with a first end and a second end, wherein the first end of the rotating shaft is coupled to the second end of the crank;
a driving rotating shaft with a first end and a second end, wherein the first end of the driving rotating shaft is coupled to the second end of the driving rotating shaft;
a driven rotating shaft with a first end and a second end, wherein the first end fo the driven rotating shaft engages the second end of the driving rotating shaft;
a first flywheel rotatably coupled to the driving rotating shaft; and
a second freewheel flywheel spaced apart from the first flywheel and rotatably coupled to the driven rotating shaft; and
a generator coupled to the second end of the driven rotating shaft.

15. The system of claim 13, wherein the at least one turbine assembly comprises:
a drive shaft with a first end and a second end, wherein the first end coupled to the plate;
a Pitman arm with a first end and a second end, wherein the first end of the Pitman arm is coupled to the second end of the drive shaft;
a crank with a first end and a second end, wherein the first end of the crank is coupled to the second end of the Pitman arm;
a ratchet mechanism with a first end and a second end, wherein the first end of the ratchet mechanism is coupled to the second end of the crank, and wherein the ratchet mechanism comprises:
a first portion coupled to the second end of the crank; and
a second portion rotatably engaging the first portion;
a freewheel flywheel rotatably coupled to the second portion of the ratchet mechanism; and
a generator coupled to a second end of the second portion of the ratchet mechanism.

16. The system of claim 13, wherein the pivot assembly comprises:
a base;
a shaft rotatably coupled to the base;
a pivoting member coupled to the shaft; and
at least one arm extend from the pivoting member and engaging the plate.

17. A method of generating electricity with a vehicle-actuated treadle system, comprising:
driving over a plate in the road to pivot the plate from a first position to a second position;
exerting a downward motion from the plate to a drive shaft of a turbine assembly of the vehicle-actuated treadle system;
converting the downward motion of the drive shaft to rotation of at least one flywheel;
spinning a generator with the rotation of the at least one flywheel; and
generating electricity from the spinning generator.

18. The method of claim 17, wherein plate pivots from the first position to the second position when a vehicle overcomes a counterweight of the plate to pivot the plate to the second position.

19. The method of claim 18, wherein the plate is angled relative to a top surface of a surrounding roadway in the first position and wherein the plate is flush with the top surface of the surrounding roadway in the second position.

20. A gravity-actuated and vehicle-actuated treadle system for generating electric power, comprising:
a plate including a counterweight coupled to a first end of the plate;
a hinge member coupled to a first end of the plate and a first road piece; and
at least one turbine assembly coupled to and extending from the bottom surface of the plate.
